(19) United States
(12) Patent Application Publication
(10) Pub. No.: US 2012/0091121 A1
(43) Pub. Date: Apr. 19, 2012

(54) HEATER STACK FOR INKJET PRINTHEADS

(76) Inventor: ZACHARY JUSTIN REITMEIER, Lexington, KY (US)

(21) Appl. No.: 12/907,282

(22) Filed: Oct. 19, 2010

(51) Int. Cl. H05B 3/10

(52) U.S. Cl. 219/553

(57) ABSTRACT

A heater stack for an inkjet printhead includes a first metallic layer. The heater stack further includes at least one heater carried by the first metallic layer and adapted to receive an electric current for heating ink prior to printing. Furthermore, the heater stack includes a dielectric layer disposed below the first metallic layer. Additionally, the heater stack includes a second metallic layer disposed below the dielectric layer, such that, the second metallic layer extends beneath the at least one heater. Moreover, the heater stack includes a substrate disposed below the second metallic layer and configured to support the first metallic layer, the at least one heater, the dielectric layer and the second metallic layer.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to inkjet printheads, and more particularly to heater stacks for the inkjet printheads.

2. Description of the Related Art

A typical thermal inkjet printhead utilizes a micro-fluid ejection device in the form of a heater chip. Further, the inkjet printhead includes a nozzle plate either attached to or integrated with the heater chip. Furthermore, the inkjet printhead includes an input/output connector, such as a tape automated bond (TAB) circuit, for electrically connecting the heater chip to a printer. The inkjet printhead also includes a source for supplying ink to the heater chip and the nozzle plate. The heater chip includes a heater stack that refers to a structure associated with a portion of the thickness of the heater chip. The heater stack includes at least one heater fabricated on one or more conductive layers and/or insulating layers.

FIG. 1 illustrates a cross sectional view of a portion 102 of a heater stack 100. The heater stack 100 includes a first metallic layer 104 made up of one or more conductive materials. Specifically, the first metallic layer 104 may be composed of aluminum-copper material. Further, the heater stack 100 includes a dielectric layer 106 disposed below the first metallic layer 104. Furthermore, the heater stack 100 includes a second metallic layer 108 disposed below the dielectric layer 106. The second metallic layer 108 carries at least one heater 110 (hereinafter referred to as “heater 110”) thereon. The second metallic layer 108 may be similar to the first metallic layer 104 and may be composed of aluminum-copper material. The dielectric layer 106, as used herein, serves as an inter-metal dielectric layer and may be composed of silicon oxide. Another example of the material that may be used for making the dielectric layer 106 is a methyl silsesquioxane (MSQ) material.

The heater stack 100 may include additional layers, such as a layer 112 composed of tantalum material and a layer 114 composed of silicon nitride material, for to fabrication of the heater 110.

The heater stack 100 also includes a substrate 116 disposed below the second metallic layer 108. Specifically, the substrate 116 acts as a support on which the second metallic layer 108, the dielectric layer 106 and the first metallic layer 104 are fabricated in order to form the heater stack 100. The substrate 116 may be composed of silicon. Moreover, the heater stack 100 includes a heater film 118 disposed below the second metallic layer 108. The heater film 118 may be a thin heater film composed of tantalum-aluminum-nitride material.

As shown in FIG. 1, the heater stack 100 may also include various other layers, such as a layer 120 disposed below the second metallic layer 108. The layer 120 may be a layer composed of either boron-doped phosphosilicate glass (BPSG) or undoped silicate glass (USG). Further, the heater stack 100 may include a layer 122 disposed below the layer 120. The layer 122 may be a layer composed of field oxide (FOX). Furthermore, the heater stack 100 may include another layer 123 disposed over the first metallic layer 104. The layer 123 may be composed of silicon oxide. It will be evident that the heater stack 100 may include such other layers that are required for fabrication of heater chips, as known in the art.

FIG. 2 illustrates a plan view of an arrangement of the first and second metallic layers 104, 108, and a path of the electric current (depicted by a directional arrow ‘A’) for the heater stack 100. As shown in FIG. 2, the heater stack 100 also includes at least one via 124 (hereinafter referred to as “via 124), formed within the heater stack 100 to facilitate the transfer of the electric current through the heater stack 100. The via 124 may be either cut or etched through the thickness of the heater stack 100. As shown in FIG. 2, the heater stack 100 includes six of such vias 124 per heater 110.

When power is supplied to the heater stack 100, the electric current is received by the first metallic layer 104. Subsequently, the electric current moves from the first metallic layer 104 down to the second metallic layer 108 through the via 124. The electric current then moves in proximity to the heater 110 within the second metallic layer 108 prior to being received by at least one Power Field Effect Transistor (pFETs) 126.

As shown in FIG. 2, the heater 110 includes a positive terminal 128 and a negative terminal 130 configured within the second metallic layer 108. As a result, a metal trace 132 of the second metallic layer 108 passes between two consecutive heaters, such as the heater 110, to appropriately arrange positive and negative terminals of the consecutive heaters. With such an arrangement, the maximum allowable heater width is limited by the ability of the heater stack fabrication process to produce the aforementioned features in a single plane of the second metallic layer 108. Such limitations subsequently control the allowable pitch of heaters, such as the heater 110.

Consequently, various alternate heater stacks have been designed to achieve a high print quality. FIG. 3 illustrates a cross sectional view of a portion 202 of a heater stack 200. The heater stack 200 includes at least one heater 204 (hereinafter referred to as “heater 204”) carried by a first metallic layer 206. The heater stack 200 may include additional layers, such as a layer 208 of tantalum material and a layer 210 of silicon nitride material, for fabrication of the heater 204.

The heater stack 200 further includes a dielectric layer 212 disposed below the first metallic layer 206. Furthermore, the heater stack 200 includes a second metallic layer 214 disposed below the dielectric layer 212. The second metallic layer 214 extends to a portion 216 of the first metallic layer 206. The first and second metallic layers 206, 214 may be composed of aluminum-copper material. The dielectric layer 212 may be a layer composed of silicon oxide. Another example of the material that may be used for making the dielectric layer 212 is a methyl silsesquioxane (MSQ) material.

The heater stack 200 also includes a substrate 218 disposed below the second metallic layer 214. Specifically, the substrate 218 acts as a support on which the first metallic layer 206, the dielectric layer 212 and the second metallic layer 214 are fabricated in order to form the heater stack 200. In addition, the heater stack 200 includes a heater film 220 disposed in between the first metallic layer 206 and the dielectric layer 212. The heater film 220 may be composed of tantalum-aluminum-nitride material.

As shown in FIG. 3, the heater stack 200 may also include various other layers, such as a layer 222 disposed below the second metallic layer 214. The layer 222 may be a layer composed of either boron-doped phosphosilicate glass (BPSG) or undoped silicate glass (USG). Further, the heater stack 200 may include a layer 224 disposed below the layer 222. The layer 224 may be a layer composed of field oxide (FOX). Furthermore, the heater stack 200 may include another layer 225 disposed over the first metallic layer 206. The layer to 225 may be composed of silicon oxide. It will be evident that the heater stack 200 may include other such layers required for fabrication of heater chips, as known in the art.

FIG. 4 illustrates a plan view of an arrangement of the first and second metallic layers 206, 214, and a path of an electric current (depicted by a directional arrow ‘B’) for the heater stack 200. As shown in FIG. 4, the heater stack 200 includes at least one via 226 (hereinafter referred to as “via 226”), formed within the heater stack 200 to facilitate the transfer of the electric current through the heater stack 200. The via 226 may be either cut or etched through the thickness of the heater stack 200. Without departing from the scope of the present disclosure, the heater stack 200 includes four of such vias 226 per heater 204.

When power is supplied to the heater stack 200, the electric current is delivered to the first metallic layer 206. Subsequently, the electric current moves in the proximity of the heater 204 through a metal trace 228 of the first metallic layer 206. The electric current then passes down to the second metallic layer 214 through the via 226. Subsequently, the electric current moves to at least one pFET 230. However, a printhead employing such a heater stack 200 is still incapable of achieving a sufficiently high print quality, again due to the limitations of spacing of heaters, as imposed by the heater stack fabrication process.

Based on above, various attempts have been made to achieve a high print quality. It should be understood that improvement in inkjet print quality depends, in part, on higher dpi values. Accordingly, various approaches have been devised to achieve a high dpi. Such approaches include, but are not limited to, offsetting multiple heater arrays by a fraction of heater pitch and increasing the native heater pitch. For example, two 600 dpi heater arrays offset by 1/1200″ provide an effective dpi of 1200. Alternatively, a single 1200 dpi heater array may be used for achieving 1200 dpi. It will be evident to a person skilled in the art that using a single 1200 dpi heater array is beneficial as smaller and cheaper chips with an equivalent number of heaters may be employed. However, spacing large heaters sufficiently close together still remains a problem while using the aforementioned approaches. Moreover, prior art simulation results have shown that modifications from the currently used heater shape, such as reducing the width of heater resistor leads, are less reliable due to increased current crowding near ends of the heaters.

Accordingly, there persists a need for a heater stack for an inkjet printhead, to which overcomes the drawbacks and limitations of prior art heater stacks. Specifically, there persists a need for a heater stack that either employs heaters with high width or employs a large number of heaters, in order to facilitate the inkjet printhead to achieve a print resolution greater than or equal to about 900 dpi.

### SUMMARY OF THE DISCLOSURE

In view of the foregoing disadvantages inherent in the prior art, the general purpose of the present disclosure is to provide a heater stack for an inkjet printhead by including all the advantages of the prior art, and overcoming the drawbacks inherent therein.

Accordingly, the present disclosure provides a heater stack for an inkjet printhead. The heater stack includes a first metallic layer. Further, the heater stack includes at least one heater carried by the first metallic layer and adapted to receive an electric current for heating ink prior to printing. Furthermore, the heater stack includes a dielectric layer disposed below the first metallic layer. Moreover, the heater stack includes a second metallic layer disposed below the dielectric layer, such that, the second metallic layer extends beneath the at least one heater. In addition, the heater stack includes a substrate disposed below the second metallic layer and configured to support the first metallic layer, the at least one heater, the dielectric layer and the second metallic layer.

### BRIEF DESCRIPTION OF THE DRAWINGS

The above-mentioned and other features and advantages of the present disclosure, and the manner of attaining them, will become more apparent and will be better understood by reference to the following description of embodiments of the disclosure taken in conjunction with the accompanying drawings, wherein:

FIG. 1 illustrates a cross sectional view of a portion of a prior art heater stack for an inkjet printhead;

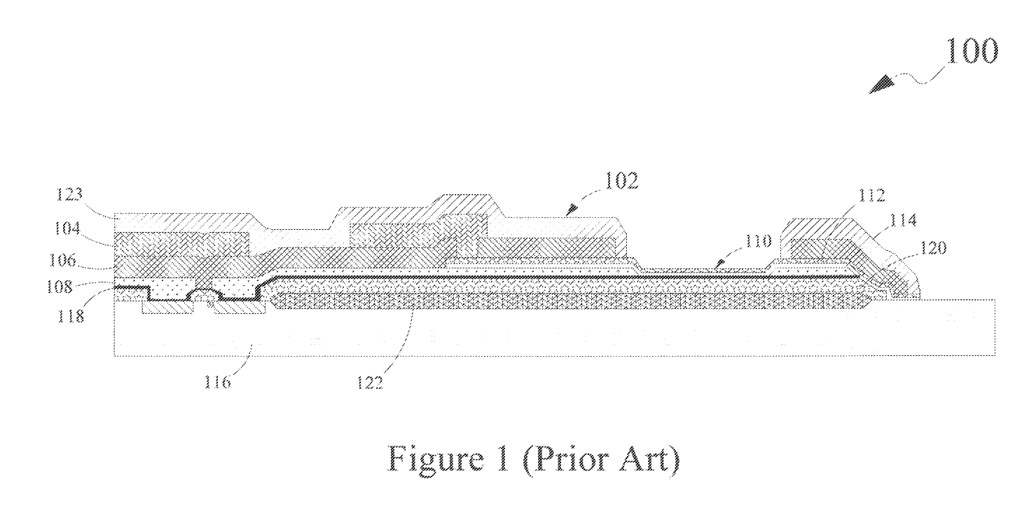

FIG. 2 illustrates a plan view of an arrangement of metallic layers and a path of an electric current for the prior art heater stack of FIG. 1;

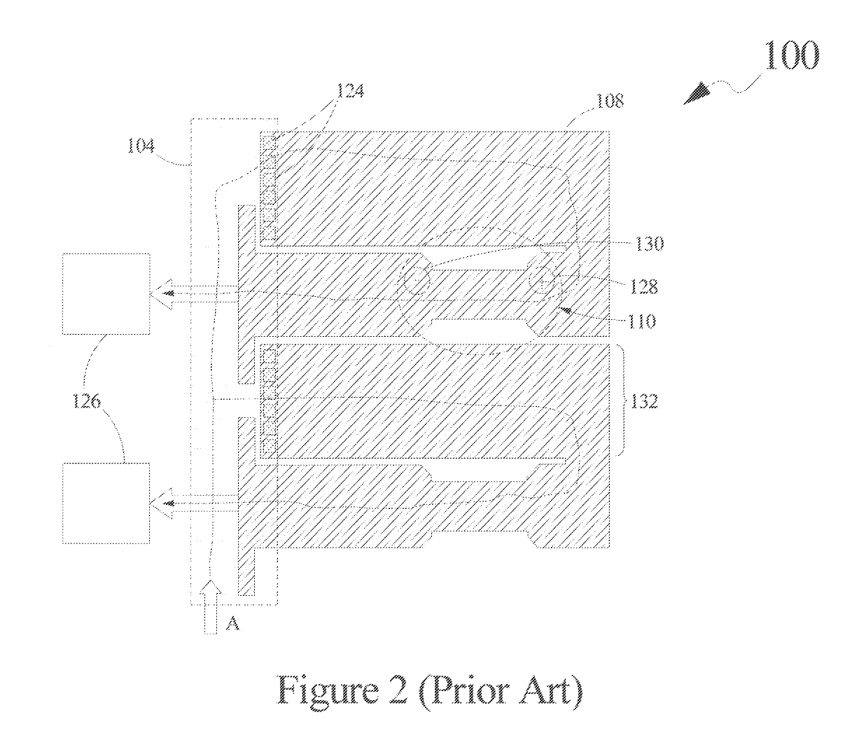

FIG. 3 illustrates a cross sectional view of a portion of another prior art heater stack for an inkjet printhead;

FIG. 4 illustrates a plan view of an arrangement of metallic layers and a path to of an electric current for the prior art heater stack of FIG. 3;

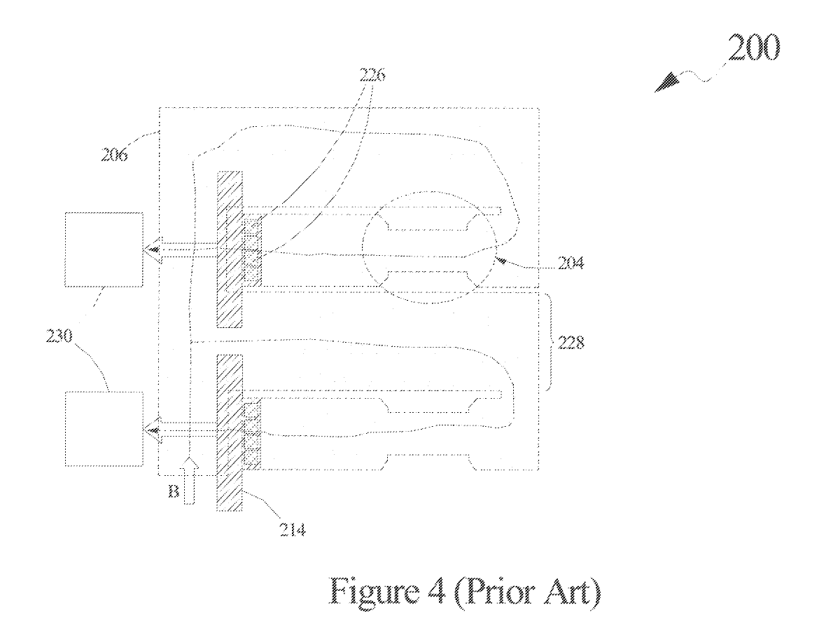

FIG. 5 illustrates a cross sectional view of a portion of a heater stack for an inkjet printhead, according to an exemplary embodiment of the present disclosure;

FIG. 6 illustrates a plan view of an arrangement of metallic layers and a path of an electric current for the heater stack of FIG. 5;

FIG. 7 illustrates a plan view of an arrangement of metallic layers and a path of an electric current for a heater stack, according to another exemplary embodiment of the present disclosure; and

FIG. 8 illustrates a plan view of an arrangement of metallic layers and a path of an electric current for a heater stack, according to yet another exemplary embodiment of the present disclosure.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

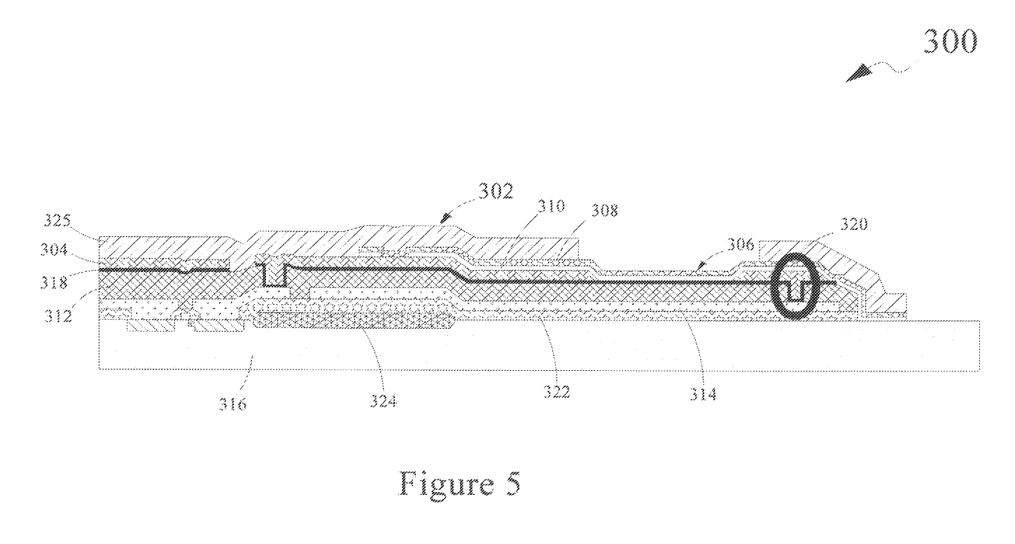

The present disclosure provides a heater stack for an inkjet printhead. The heater stack includes a first metallic layer. The heater stack further includes at least one heater carried by the first metallic layer and adapted to receive an electric current for heating ink prior to printing. Furthermore, the heater stack includes a dielectric layer disposed below to the first metallic layer. In addition, the heater stack includes a second metallic layer disposed below the dielectric layer, such that, the second metallic layer extends beneath the at least one heater. Moreover, the heater stack includes a substrate disposed below the second metallic layer and configured to support the first metallic layer, the at least one heater, the dielectric layer and the second metallic layer. Various embodiments of the heater stack of the present disclosure are explained in detail in conjunction with FIGS. 5-8.

Referring to FIG. 5, a cross sectional view of a portion 302 of a heater stack 300 for an inkjet printhead is depicted, according to an exemplary embodiment of the present disclosure. The heater stack 300 includes a first metallic layer 304. The first metallic layer 304 is an aluminum-copper layer.

The heater stack 300 includes at least one heater 306 (hereinafter referred to as “heater 306”) carried by the first metallic layer 304 and adapted to receive an electric current for heating ink prior to printing. The heater stack 300 may include additional layers, such as a layer 308 composed of tantalum material and a layer 310 composed of silicon nitride material, for fabrication of the heater 306.

Furthermore, the heater stack 300 includes a dielectric layer 312 disposed below the first metallic layer 304. The dielectric layer 312 may be a layer composed of silicon oxide. Alternatively, the dielectric layer 312 may be a layer composed of materials, such as methyl silsesquioxane (MSQ) material, which exhibit low thermal conductivity.

In addition, the heater stack 300 includes a second metallic layer 314 disposed below the dielectric layer 312, such that, the second metallic layer 314 extends beneath the heater 306. The second metallic layer 314 may be a continuous layer extending beneath the heater 306. However, the second metallic layer 314 may be a layer having a minimal number of gaps therebetween. Further, the second metallic layer 314 is an aluminum-copper layer.

Moreover, the heater stack 300 includes a substrate 316 disposed below the second metallic layer 314 and configured to support the first metallic layer 304, the heater 306, the dielectric layer 312 and the second metallic layer 314. The substrate 316 may be composed of silicon.

The heater stack 300 further includes a heater film 318 between the first metallic layer 304 and the dielectric layer 312. The heater film 318 may be composed of tantalum-aluminum-nitride (TaAlN) material.

Additionally, the heater stack 300 includes at least one via 320 (hereinafter referred to as “via 320”) formed within the heater stack 300 to facilitate the transfer of the electric current between the heater 306 and the second metallic layer 314.

As shown in FIG. 5, the heater stack 300 may also include various other layers, such as a layer 322 disposed below the second metallic layer 314. The layer 322 may be a layer composed of either boron-doped phosphosilicate glass (BPSG) or undoped silicate glass (USG). Further, the heater stack 300 may include a layer 324 disposed below the layer 322. The layer 324 may be a layer composed of field oxide (FOX). Furthermore, the heater stack 300 may include another layer 325 disposed over the first metallic layer 304. The layer 325 may be composed of silicon oxide. It will be evident that the heater stack 300 may include other such layers required for fabrication of heater chips, as known in the art.

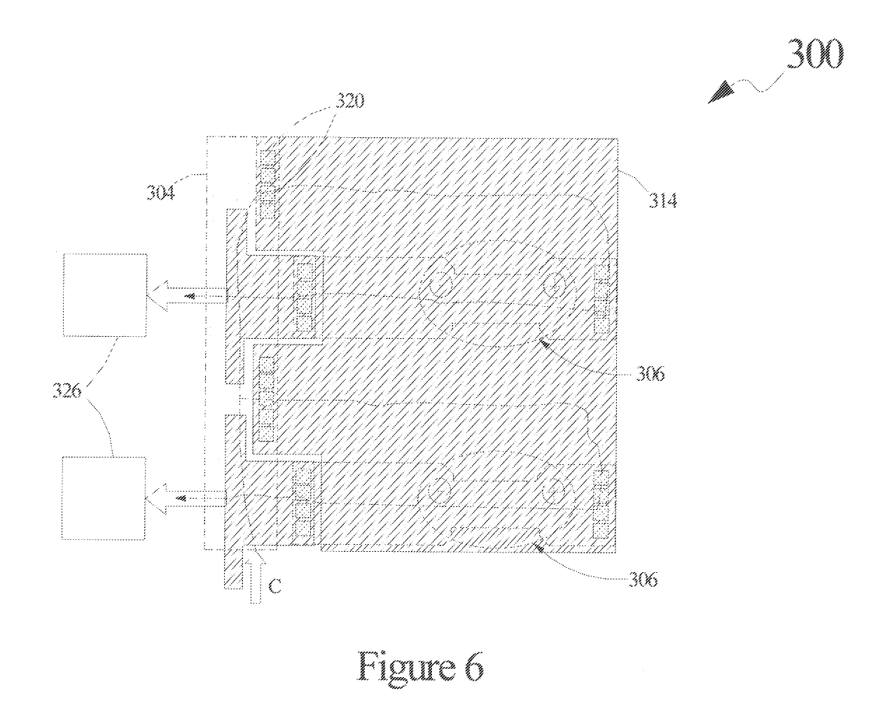

FIG. 6 illustrates a plan view of an arrangement of the first and the second metallic layers 304, 314, and a path of the electric current for the heater stack 300. The electric current, as shown by a directional arrow “C”, travels within the first metallic layer 304 and then down to the second metallic layer 314 beneath the heater 306 carried by the first metallic layer 304. The electric current then travels up through the via 320 to the first metallic layer 304 carrying the heater 306 thereon. Subsequently, the electric current passes through the heater 306 and then back down to the second metallic layer 314 and to at least one Power Field Effect Transistor (pFETs) 326.

As shown in FIG. 6, high voltage sides (indicated by “+” signs) of consecutive heaters, such as the heater 306, may be tied together in large groups. Accordingly, the second metallic layer 314 may be configured as a nominally planar layer beneath the heater 306, thereby averting the need of employing any special planarization steps during fabrication.

Based on the foregoing, the arrangement of the first and the second metallic layers 304 and 314 facilitates in eliminating the requirement of any metal trace of the first metallic layer 304 around the heater 306 for passage of the electric current therethrough. Specifically, extension of the second metallic layer 314 beneath the heater 306 facilitates the electric current to pass underneath the heater 306 into the second metallic layer 314. Accordingly, the change in path of the electric current in comparison to the path of the to electric current of prior art heater stacks, such as the heater stacks 100 and 200, averts the utilization of any metal trace of the first metallic layer 304 between two consecutive heaters. Accordingly, free space is available between two consecutive heaters, such as the heater 306, on the first metallic layer 304 of the heater stack 300.

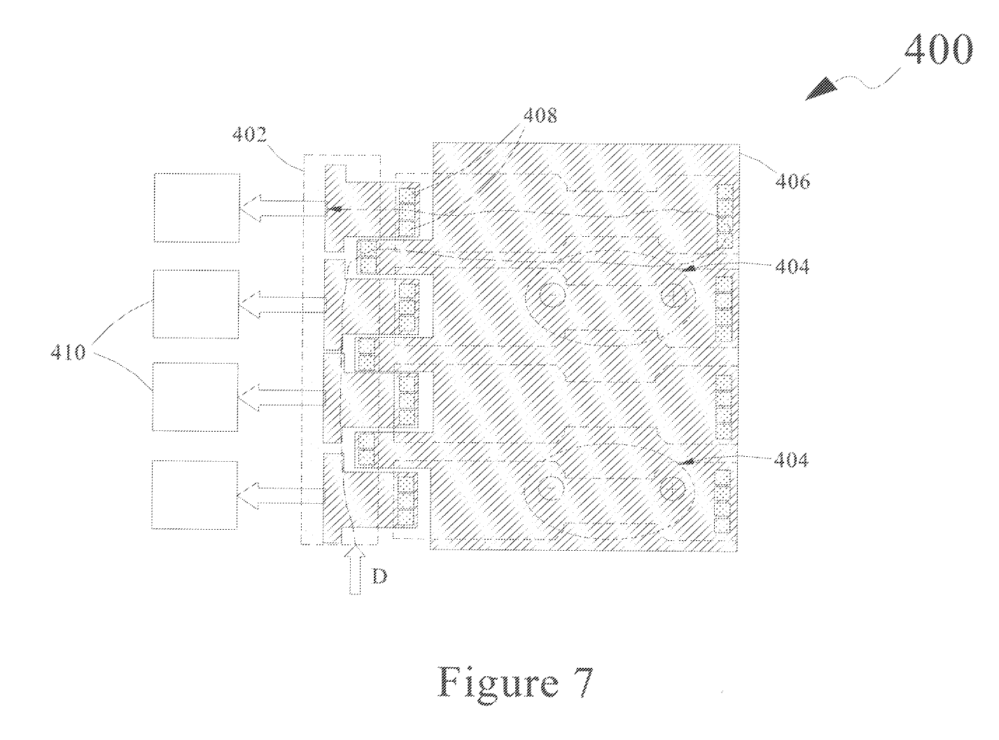

FIG. 7 illustrates a plan view of an arrangement of first and second metallic layers, and a path of an electric current for a heater stack 400, according to another exemplary embodiment of the present disclosure. The heater stack 400 is similar to the heater stack 300 of FIG. 6. Specifically, the heater stack 400 includes a first metallic layer 402 similar to the first metallic layer 304, at least one heater 404 (hereinafter referred to as “heater 404”) similar to the heater 306, a second metallic layer 406 similar to the second metallic layer 314, and at least one via 408 (hereinafter referred to as “via 408”) similar to the via 320. Without departing from the scope of the present disclosure, the heater stack 400 includes four of such heaters 404. Accordingly, the heater stack 400 employs twice the number of heaters that are employed in the heater stack 300, due to availability of free space on the first metallic layer 402. Accordingly, the free space of the first metallic layer 402 may be utilized for fitting a higher number of heaters, such as the heater 404, having a size and shape similar to the heater 306 of FIG. 6 in a predetermined area. As shown in FIG. 7, the passage of the electric current (depicted by a directional arrow “D”) through the heater stack 400 and then into at least one pFET 410 is similar to the passage of the electric current for the heater stack 300.

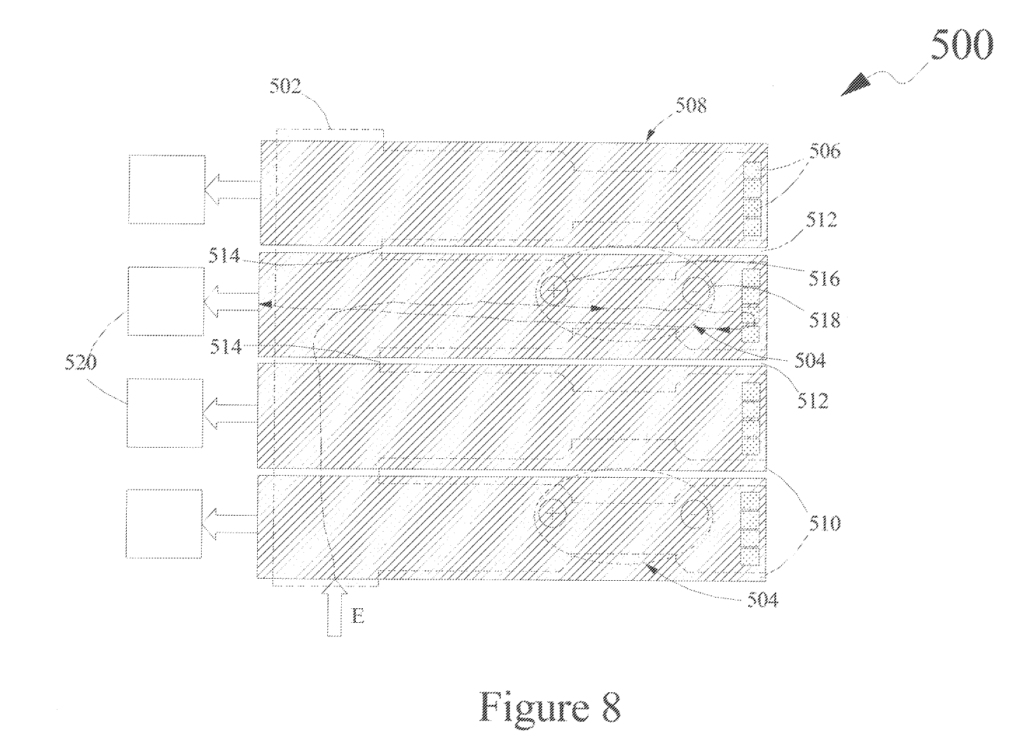

FIG. 8 illustrates a plan view of an arrangement of metallic layers and a path of an electric current for a heater stack 500, according to yet another exemplary embodiment of the present disclosure. The heater stack 500 is similar to the heater stack 300 of FIG. 6. Specifically, the heater stack 500 includes a first metallic layer 502 similar to the first metallic layer 304, at least one heater 504 (hereinafter referred to as “heater 504”) similar to the heater 306, and at least one via 506 (hereinafter referred to as “via 506”) similar to the via 320. Without departing from the scope of the present description, the heater stack 500 includes four of such heaters 504.

However, the heater stack 500 includes a second metallic layer 508 that includes a plurality of spaced-apart sections 510. Specifically, the spaced-apart sections 510 altogether constitute the second metallic layer 508. Further, two consecutive spaced-apart sections of the spaced-apart sections 510 are separated by a gap 512, and each section of the spaced-apart sections 510 extends beneath a corresponding heater 504. The gap 512 may be configured between a corresponding split 514 in the overlying first metallic layer 502 in order to configure the heater 504 over a flat area. Additionally, the heater stack 500 includes a dielectric layer (not shown) that may planarize the gap 512 enabling the heater 504 to be configured in a plane.

As depicted by a directional arrow “E”, the electric current passes through the heater 504 carried by the first metallic layer 502. Subsequently, the electric current moves down to the second metallic layer 508 through the via 506, and to at least one pFET 520.

As shown in FIG. 8, high voltage side 516 (indicated by “+” sign) and low voltage side 518 (indicated by “−” sign) of the heater 504 are reversed as opposed to the heater 306 of FIG. 6. Further, high voltage sides of the four of the heaters 504 are tied together only in the first metallic layer 502.

The description of the present disclosure is further illustrated by the following non-limiting example that shows a comparison between the heater stack of the present disclosure, such as the heater stack 300, and a prior art heater stack, such as the heater stack 200. However, one of ordinary skill in the art, and based on a reading of this detailed description, would recognize that, the specific example is intended to illustrate, not limit, the scope of the present disclosure.

### Example 1

Jetting response of the heater stack 300 of the present disclosure was compared with the jetting response of the prior art heater stack 200, to determine any deleterious effect of extending the second metallic layer 314 underneath the heater 306. Specifically, simulations were run comparing the heater stacks 300 and 200. All inputs were held constant other than the heater stacks 300 and 200. Table 1 shows key results of the simulations.

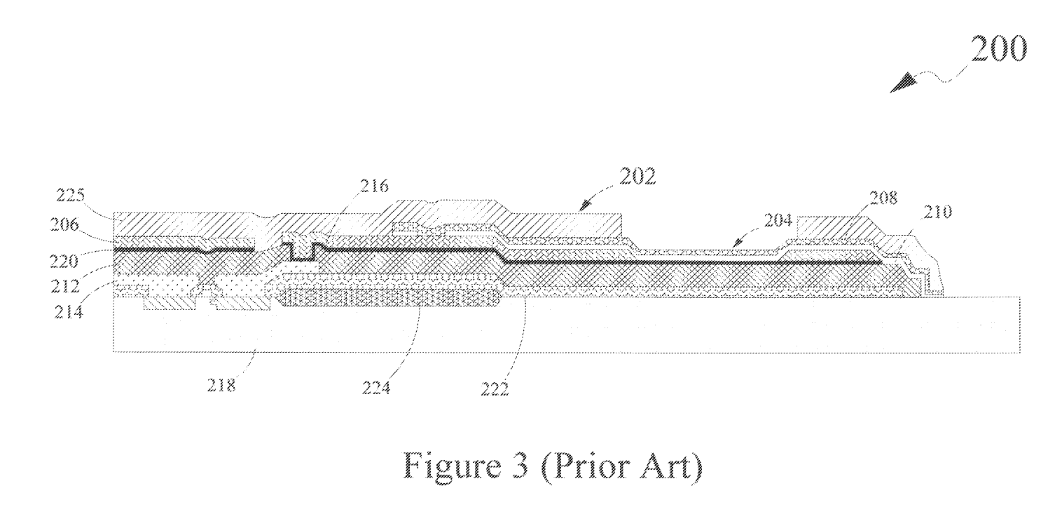

TABLE 1

| | Heater Stack 200 | Heater Stack 300 |
|---|---|---|
| Parameters | of Figure 3 | of Figure 5 |
| Displaced nozzle volume (pI) | 1.75 | 1.84 |
| Estimated drop velocity (in/s) | 499 | 514 |
| Energy into ink (%) | 41.60 | 41.70 |
| Energy into Silicon Substrate | 13.30 | 8.40 |
| (%) | | |
| Change in maximum | 368 | 349 |
| temperature (ΔTₘₐₓ) at the | | |
| end of fire pulse | | |
| Minimum Cycle (time to | 18.5 | 16.5 |
| cool to 42 C.) (μs) | | |

It may be observed that the percentage of energy delivered to ink for jetting while using the heater stack 300 was similar to the percentage of energy delivered to ink for to jetting while using the heater stack 200. However, the percentage of energy delivered to the silicon substrate while using the heater stack 300 was slightly less than the percentage of energy delivered to the silicon substrate while using the heater stack 200. Specifically, some percentage of energy was absorbed in the silicon substrate and some percentage of energy was dissipated in the second metallic layer 314 that extends beneath the heater 306. Further, the extension of the second metallic layer 314 beneath the heater 306 also contributed to a slightly faster cooling response in comparison to the cooling response of the heater stack 200 (as observed from the results for minimum cycle in Table 1). Accordingly, the presence of the second metallic layer 314 beneath the heater 306 did not exhibit any deleterious effect on the jetting response.

The present disclosure provides a heater stack (such as the heater stacks 300, 400 and 500), having a metallic layer (such as the second metallic layers 314, 406 and 508) disposed beneath at least one heater (such as the heaters 306, 404 and 504), carried by another metallic layer (such as the first metallic layers 304, 402 and 502). The heater stack allows for a multi-level distribution of power/electric current in and out of the at least one heater. Further, the heater stack facilitates the electric current to pass beneath the at least one heater to make space available on the metallic layer carrying the at least one heater either for employing wider heaters or for increasing density of the heaters. Consequently, such a heater stack may enable an inkjet printhead to achieve a print resolution equal to or greater than about 900 dpi. Specifically, an inkjet printhead employing the heater stack of the present disclosure may achieve a print resolution of about 1800 dpi. Additionally, the heater stack of the present disclosure utilizes either a continuous metallic layer, or a metallic layer with minimal gaps beneath the overlying metallic layer that carries the at least one heater. Such an arrangement does not affect the planarity in heater area. Moreover, the arrangement does not exhibit any adverse effect on jetting response of the inkjet printhead. In addition, large heaters that are spaced very closely to each other may be employed in the heater stack of the present disclosure for non-printing applications where larger drop sizes may be of interest.

The foregoing description of several embodiments of the present disclosure has been presented for purposes of illustration. It is not intended to be exhaustive or to limit the disclosure to the precise forms disclosed, and obviously many modifications and variations are possible in light of the above teaching. It is intended that the scope of the disclosure be defined by the claims appended hereto.

What is claimed is:

1. A heater stack for an inkjet printhead, the heater stack comprising:
a first metallic layer;
at least one heater carried by the first metallic layer and adapted to receive an electric current for heating ink prior to printing;
a dielectric layer disposed below the first metallic layer;
a second metallic layer disposed below the dielectric layer, such that, the second metallic layer extends beneath the at least one heater; and
a substrate disposed below the second metallic layer and configured to support the first metallic layer, the at least one heater, the dielectric layer and the second metallic layer.

2. The heater stack of claim 1 further comprising a heater film between the first metallic layer and the dielectric layer.

3. The heater stack of claim 2, wherein the heater film is composed of tantalum-aluminum-nitride (TaAlN) material.

4. The heater stack of claim 1 further comprising at least one via formed within the heater stack to facilitate the transfer of the electric current between the at least one heater and the second metallic layer.

5. The heater stack of claim 1, wherein the second metallic layer is a continuous layer.

6. The heater stack of claim 1, wherein the second metallic layer comprises a plurality of spaced-apart sections, wherein each section of the plurality of spaced-apart sections extends beneath a corresponding heater of the at least one heater.

7. The heater stack of claim 1, wherein the dielectric layer is a layer composed of silicon oxide.

8. The heater stack of claim 1, wherein the dielectric layer is a layer composed of methyl silsesquioxane (MSQ) material.

9. The heater stack of claim 1, wherein the first metallic layer is an aluminum-copper layer.

10. The heater stack of claim 1, wherein the second metallic layer is an aluminum-copper layer.

11. The heater stack of claim 1, wherein the substrate is composed of silicon.
